(19) United States
(12) Patent Application Publication
(10) Pub. No.: US 2005/0075907 A1
(43) Pub. Date: Apr. 7, 2005

(54) Emergency station kiosk and related methods

(76) Inventor: John Rao, Tempe, AZ (US)

Correspondence Address: Kenneth C. Booth;Schmeiser Olsen & Watts, LLP, 18 E. University Dr. #101, Mesa, AZ, 85201, US

(21) Appl. No.: 10/996,296

(22) Filed: Nov. 22, 2004

Related U.S. Application Data
(63) Continuation-in-part of application No. 10/389,363, filed on Mar. 14, 2003.

(51) Int. Cl. G06F 17/60

(52) U.S. Cl. 705/2

(57) ABSTRACT

Applications of the present invention are particularly useful in providing a system that allows the secure distribution of medical documents through a medical kiosk. The medical kiosk includes a customer interface and a camera that captures an image of the customer and attaches the image to a medical document. In order to receive a medical document through the kiosk, a customer requests a medical examination, enters information into the system by answering questions, and using medical instruments, and then requests the medical document. A picture of the customer is captured for attachment to the medical document. Another embodiment of the invention allows a customer to communicate directly with a medical professional during the examination process through a customer interface with the kiosk.

### CROSS REFERENCE TO RELATED APPLICATIONS

This application is continuation-in-part of patent application by Rao entitled “PRESCRIPTION DRUG DISTRIBUTION SYSTEM AND METHODS,” Ser. No. 10/389,363, filed on Mar. 14, 2003, the disclosure of which is hereby incorporated herein by reference.

### BACKGROUND OF THE INVENTION

1. Technical Field

This invention relates generally to a medical kiosk and related methods for distributing medical documents. It relates more specifically to a medical kiosk through which medical services and medical documents are provided.

2. Background Art

With the advent of the internet and other new technologies, it has become possible to make medical services available where they have not been available in the past. This has been illustrated partly by the growing industry of mail order and online pharmacies. These companies allow customers to research, select and request a desired drug. The customer then answers questions posed by an online doctor and the prescription for the requested drug is granted. These companies, however, can only grant prescriptions to a group of prescription drugs known in the industry as “lifestyle” drugs that are not necessary for the health of the patient, but may improve the quality of life for the patient. Some examples of lifestyle drugs include, but are not limited to, drugs for weight loss, hair loss, erectile dysfunction, pain relief from arthritis, allergies, herpes, birth control, skin care, smoking, and the like. Though a step in the right direction, these companies do not provide access to medical care which is necessary for the health of the patient.

U.S. Pat. Nos. 6,046,761 and 5,801,755 awarded to Echerer detail an interactive communication system for providing medical services to remotely located patients. This system provides video and audio interaction between the patient and a medical practitioner who may be many miles away.

A problem, however, with both the internet pharmacies and the Echerer system is that they only confirm that the customer has the right ID card, which could easily be faked. Accordingly, what is needed is a system that allows for the convenience of internet pharmacies and the Echerer system, yet provides security so that the customer obtaining the medical service is permanently associated with the result of the service regardless of the ID card shown.

### DISCLOSURE OF THE INVENTION

The present invention relates to methods and systems for distributing medical documents and medical services through a medical kiosk. Aspects of the invention include a kiosk that contains a customer interface. The interface allows customers to communicate with medical professionals to obtain medical documents. Examples of medical documents include prescriptions, letters concerning the health of the customer, referrals, test requests and the like. Specific embodiments of the present invention are particularly useful for providing medical services conveniently and at remote locations. In particular embodiments, a photograph is taken of the customer requesting the medical document and that photograph is then attached to the medical document so that the identity of the customer to which the medical document corresponds can be confirmed.

Customers approach or enter the medical kiosk and access the customer interface. The customer interface may consist of audio and visual capabilities such as a monitor which allows the customer to see and hear a medical professional. It may also contain a video camera which allows the medical professional to see and hear the customer. The customer interface may also have medical instruments, such as a stethoscope, attached. This allows the customer to conduct a medical examination of him/herself while being supervised by the medical professional. The data from the examination is then transmitted to the medical professional in order to allow the medical professional to determine the health of the customer. The medical professional may then issue a medical document to the customer.

As the medical document is requested, such as at a point during the examination, a photograph is taken of the customer. This photograph is attached to the medical document in order to provide anyone presented with the document a way to determine whether or not the person presenting the document is the customer who was actually examined. This helps to prevent fraud and mistreatment of medical patients.

The foregoing and other features and advantages of the present invention will be apparent from the following more detailed description of the particular embodiments of the invention, as illustrated in the accompanying drawings.

### BRIEF DESCRIPTION OF THE DRAWINGS

FIG. 1 is a perspective view of a medical kiosk configured according to an embodiment of the present invention;

FIG. 2 is a side view of a medical kiosk configured as a booth according to a second embodiment of the present invention;

FIG. 3 is a flow chart of a medical document distribution method according to an embodiment of the present invention;

FIG. 4 is a prescription generated according to an embodiment of the present invention;

FIG. 5 is a block diagram of a medical document distribution system configured according to a first embodiment of the present invention; and

FIG. 6 is a block diagram of a medical document distribution system configured according to a second embodiment of the present invention.

### DETAILED DESCRIPTION OF EMBODIMENTS OF THE INVENTION

As discussed above, embodiments of the present invention relate to methods for distributing medical documents and services through the use of a medical kiosk. Examples of medical documents include prescriptions, letters concerning the health of the customer, medical referrals, test requests and the like. Through the use of embodiments of the present invention, convenience, accessibility and security in providing medical services are increased.

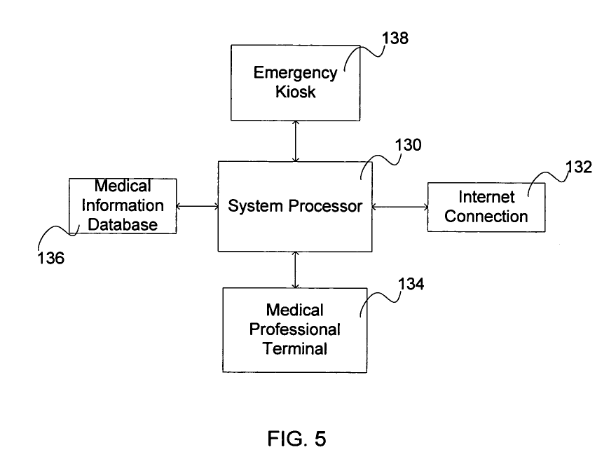

FIG. 5 illustrates a first embodiment of a system for distributing prescription medications and medical services through the use of a medical kiosk 138 configured according to an embodiment of the invention. The medical kiosk 138 communicates with a system processor 130 which also communicates with a medical professional terminal 134. This allows a medical professional to communicate with a customer at a kiosk 138. The kiosk 138 allows a medical professional to conduct a remote medical examination and to issue medical documents from a remote location. The system may also include access to the internet 132 and to a medical information database 136. Communications with a medical professional may be accomplished through a medical kiosk 138 configured according to the embodiments described below.

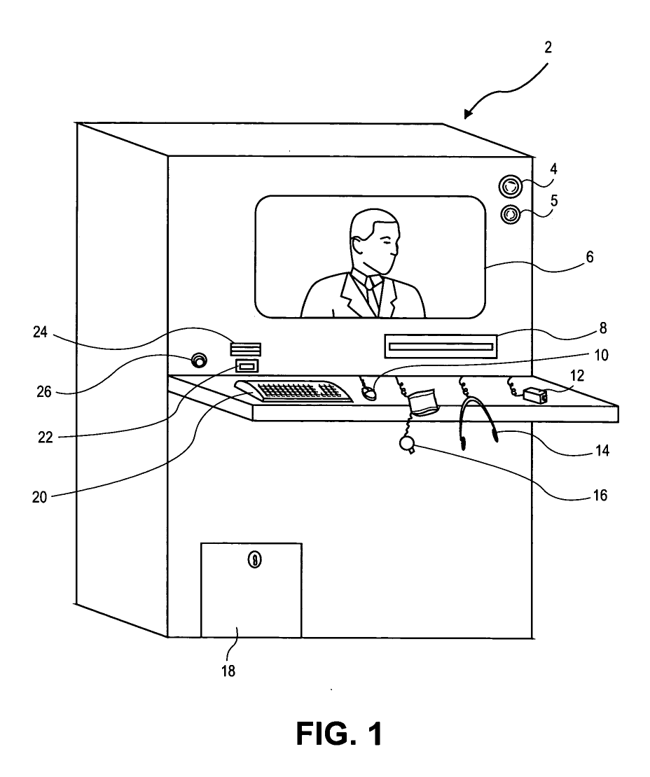

FIG. 1 illustrates one example of a medical kiosk 2 configured according to an embodiment of the invention. Kiosks having connection to a computer network or for connection to the Internet are known in the art and are available for purchase through kiosk companies such as Affordable Kiosks on the Internet at affordablekiosks.com. Conventional kiosks include an input device such as a computer keyboard 20, which may also include a cursor controller 10 such as a mouse, touch-pad or track ball. The kiosk 2 of the present invention also includes a display 6, a credit card reader 24 and/or a currency acceptor 22, and a camera 4. The kiosk 2 may also contain an emergency button 26, a portable video camera 12, an emergency first aid kit 18 and other portable medical instruments such as a stethoscope 14, blood pressure cuff 16, otoscope, ophthalmoscope, tuning fork and the like. An x-ray machine and a MRI machine may also be attached to the kiosk 2 for rapid data transfer to the doctor.

The display 6, credit card reader 24, currency acceptor 22, emergency button 26, medical instruments 14 and 16, portable video camera 12, camera 4 and the like, are all parts of a customer interface. The customer interface consists of any devices through which the customer interacts with the kiosk, a computer or the distribution system.

The display 6 may be of a kind typical to kiosks for viewing images transmitted to the display 6. Additionally, as is common with kiosks, the display 6 may be a touch sensitive screen for interacting with the kiosk 2. In particular embodiments using a touch screen, it may not be necessary for interacting with the kiosk 2. In particular embodiments using a touch screen, it may not be necessary to include a keyboard because simple interaction may be accomplished through the touch screen. In other embodiments, however, both a touch sensitive display 6 and a keyboard 20 and/or a cursor controller 10, will be used in combination to enable interaction. Some form of verbal interaction or sound receiving and/or transmitting device (e.g. a speaker or microphone on the kiosk or a telephone handset), may be used to enable a customer to verbally interact with a person or system associated with the kiosk 2. It will be understood to those of ordinary skill in the art that instructions may be given and questions asked to the customer through either the display 6, a verbal interaction device, a touch screen display 6 or a keyboard 20. Numerous combinations of interaction using these interaction tools may also be used to accomplish the purposes of the present invention. A verbal interaction device, however, gives the particular ability to enable easy interaction with the system or a live person, such as a pharmacist, doctor, medical professional or help desk, to ask questions, or for the doctor or medical professional to ask questions and examine the customer.

The camera 4 is included in the kiosk 2 of embodiments of the present invention to capture a facial image of the customer requesting the medical document proximate the time the customer requests the document. Capturing a facial image of the customer who requested the medical document and of whom the medical examination was taken may be accomplished in a number of ways known to those of ordinary skill in the art and may include, without limitation stationary or moving digital or analog photography as well as other forms of capturing an image of the customer. As used herein, capturing an image of the customer “proximate” the time the customer requests the medical document means capturing the image of the customer at or around the time the customer requests the document, is examined, and/or reviews the information at the terminal, and does not include capturing an image of the customer which was taken at a previous time, such as a drivers license photo, or merely transferring a previously captured image of the customer on file. The picture feature of the invention is intended to provide added security and, therefore, should be an image of the actual customer of the medical document.

A video camera 5 may also be included in the kiosk 2 of embodiments of the present invention. The video camera 5 allows the customer to be viewed by a medical professional such as a doctor. The video camera 5 may also be moveable and zoomable. It allows the customer and the doctor to interact, the customer showing the doctor various symptoms and the doctor asking questions and giving directions to the customer. The video camera 5 would also allow the doctor to supervise the customer's use of any medical instruments attached to the kiosk 2 in order to assure that the customer takes the readings appropriately. The video camera 5 and other electronically recorded instrument data would also provide a record of the examination that may be stored electronically and recalled later. The camera 4 and the video camera 5 may be combined into a single camera that takes videos but is also capable of capturing still images.

The kiosk 2 may also have an emergency button 26. The emergency button 26 signals a remote medical professional that a medical emergency is underway. Medical professionals then immediately report to a remote terminal which allows them to interact with the customer. Along with an emergency button 26, the kiosk 2 may contain an emergency first aid kit 18. This first aid kit 18 may be stored in a compartment in the kiosk 2. The remote medical professional would then be able to direct the treatment of the customer undergoing the medical emergency.

Medical instruments such as a stethoscope 14, a blood pressure cuff 16, otoscope, ophthalmoscope, tuning fork, x-ray machine, MRI machine and the like may be attached to the kiosk 2. These medical instruments allow the customer to conduct a self examination with the readings from the instruments being electronically recorded and sent to a medical professional for evaluation. Medical instruments that can be attached to and read by a computer system are available through AMD of Sunnyvale, Calif.

The kiosk 2 may also have a credit card reader 24 and a cash acceptor 22 in order to allow the customer to pay for medical services at the time they are rendered through the kiosk. A printer 8 is attached to the kiosk 2 so that the requested medical documents may be printed instantly on the appropriate paper. A portable video camera 12 may also be attached so that the customer may focus in on a rash or other ailment that the medical professional would need to view.

The kiosk 2 also includes a power supply (not shown) to supply power to the kiosk 2, and a network connection (also not shown) to enable the transfer of data to and from the kiosk 2. Power supplies may include for example, a plug plugged into a standard outlet, or may include a battery or other power supply which does not require external connection. Similarly, the network connection to the kiosk 2 may include a direct connection to a data source, such as through a co-axial, telephone, network or other cable connection, or may include, without limitation, a wireless connection, such as Bluetooth transmissions, cellular transmissions, radio or other frequency transmissions, and the like. Power and network connection possibilities and configurations are well known in the art and those of ordinary skill in the art will readily be able to properly configure embodiments of the present invention for power and network connection from the description provided herein.

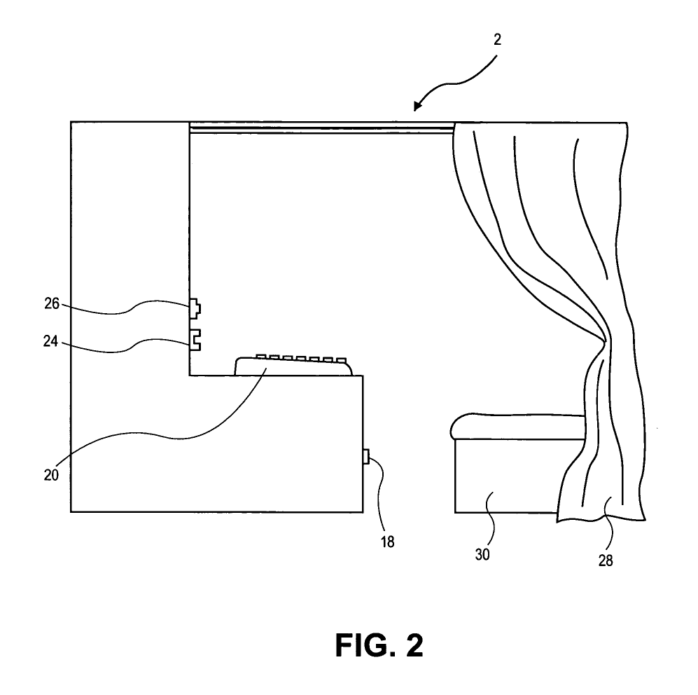

FIG. 2 illustrates the medical examination kiosk of FIG. 1 configured as a booth to provide privacy for customers receiving medical examinations. The kiosk 2 contains a seat 30 and a curtain 28 that may be closed to provide privacy.

FIG. 5 is a block diagram of a simplified example of the connectivity of a medical services and prescription distribution system configured according to an embodiment of the present invention. The system includes a medical kiosk 138, a medical professional terminal 134, a medical information database 136 and an internet connection 132, each coupled to a system processor 130. Each of these connections may be accomplished by any combination of wired or wireless connection. Each or any of the components 138, 134, 136, 132 and 130 of the system may be located in a pharmacy, or in other remote location such as a doctor's home or office, particularly in cases where the kiosk 138 allows access to experts in certain medical fields, or even in a retail store, such as a grocery store, shopping mall, or any other place where it is desirable to have customers come. Those of ordinary skill in the art will understand how to build an appropriate configuration of components for a given situation from the disclosure provided herein.

Customer requests for medical documents and medical examinations made through the kiosk 138 are transmitted electronically to and processed by the system processor 130. Information contained within the document request is compared with previous medical data within the medical information database 136, and is approved by a doctor reviewing the circumstances of each request and each medical examination through the medical professional terminal 134. Return customers may be given a user ID and password to avoid the need to reenter basic personal information. It should be understood that any or all of the components of the system may be implemented using conventional personal computers associated as a network, provided the medical kiosk 138 includes a camera associated therewith and programmed to take a facial image of the user proximate the time of the examination.

The medical kiosk 138 may also include a video camera and voice interaction device to allow the customer and the medical professional to interact. It is possible, however, that a customer could conduct a medical self examination, following instructions provided through the kiosk 138, and that the doctor could review the information received at a later time. In most embodiments, however, the kiosk 138 will be configured for general public use as a kiosk, and the medical professional terminal 134 will more likely be configured as a personal computer. The doctor may approve the request and issue the medical document which is sent to a pharmacy or other entity if requested by the customer, or the document may simply be issued and printed at the kiosk 138.

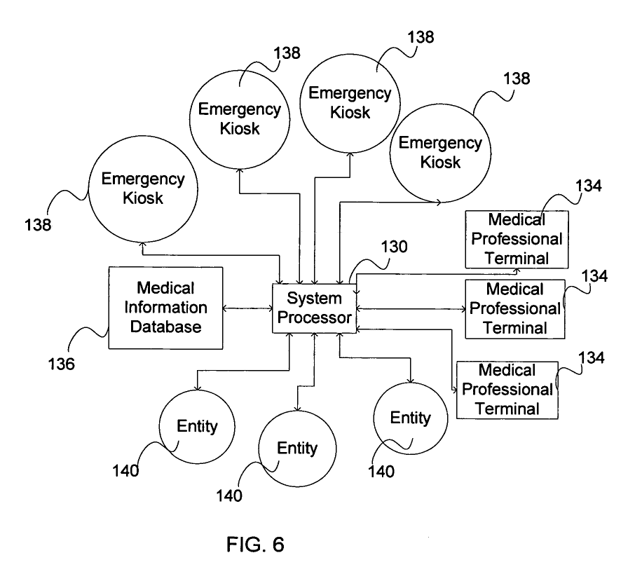

FIG. 6 is a block diagram illustrating a more complex example of the connectivity of a medical services or document distribution system configured according to another embodiment of the present invention. In this embodiment, the system comprises a plurality of medical kiosks 138 that may be located at one or more physical locations, such as at a plurality of remote pharmacies, or two or more may be located in close proximity such as within a shopping mall where many people may desire to use the kiosks 138 simultaneously. Similarly, the system of FIG. 6 comprises a plurality of medical professional terminals 134 through which a plurality of doctors or medical professionals may issue and approve medical documents or conduct medical examinations. A plurality of entities 140 may be associated with the system so that customers may select the pharmacy or other entity to which the medical document will be sent. To achieve benefit from embodiments of the present invention, a pharmacy or other entity 140 need only have a fax machine or email to receive a medical document. The processor 130 may be configured to electronically fax a medical document to any entity 134. However, in more advanced systems, the entity 134 may include a computer for receiving and reviewing the medical document electronically, and/or a printer, copier or fax machine for creating a hard copy of the prescription depending upon the needs of the entity. The entities 140 of embodiments of the present invention may be pharmacies, doctor's offices, hospitals, employers, schools, government offices or any other entity that the customer may need to send medical documents to. The entities 140, particularly pharmacies, may be adapted to send requested pharmaceuticals by carrier, such as is currently done with cyber-pharmacies but with the added security of comparing the customer's requests with the medical information database 136 (including the shipping address and the customer's picture). Software, such as that distributed by IQ Biometrix, Inc. of Fremont, Calif., exists which can compare facial images to determine identity like a finger print. Use of this software to compare faces of each requestor of medical documents may help to eliminate fraud and situations where a customer requests multiple prescriptions using different names, and even different mailing addresses. Though, a visual comparison made by the requestor of the medical document may also be sufficient. Additionally, the customer's picture may be included on a shipping label if prescription drugs are sent through the mail. This allows the delivery person to ensure the drugs were delivered to the correct person. Conventional cyber-pharmacy systems require a signature by the requestor when the delivery is made. This, however, does not ensure security as the signator may be signing a different name. Use of this system, for example, would enable customers to have their prescriptions forwarded to and filled by a Canadian or other out-of-country pharmacy for shipment to the customers' homes in the United States.

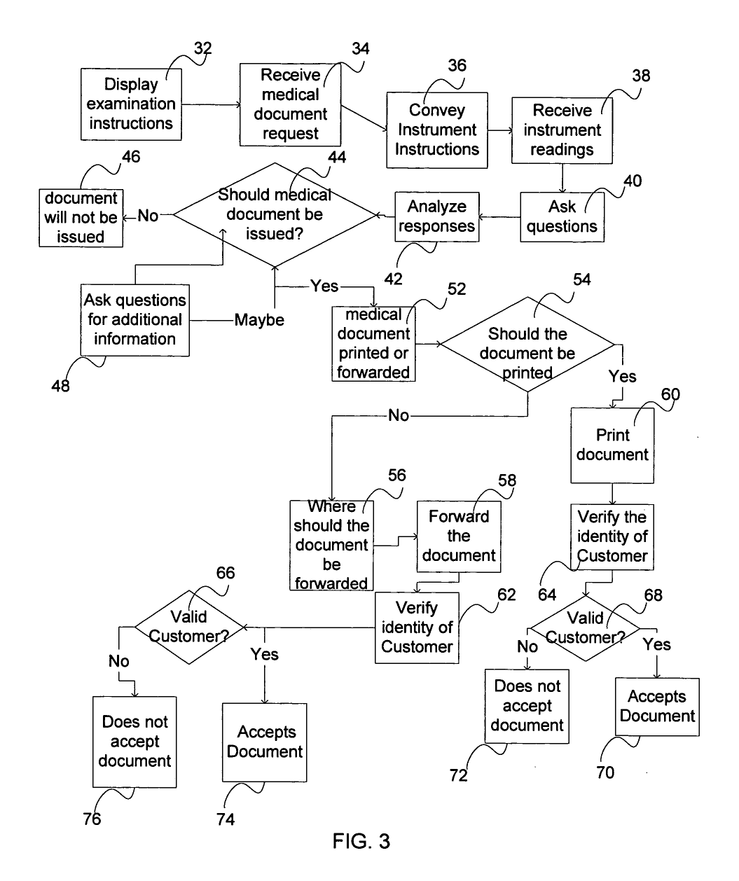

FIG. 3 includes a flow chart of a method of distributing medical documents and medical services according to a particular embodiment of the present invention. The method may be accomplished through a system having components such as those shown and described with reference to FIGS. 1-2 and 5-6. Instructions on how to begin a medical examination through the kiosk are displayed on the kiosk (Step 32). Thereafter, the customer initiates, and the system receives, an examination and medical document request (Step 34). At the time the customer makes the request for a medical document, a camera associated with the system will capture an image of the customer. Part of making the request for a medical examination and medical documents for particular embodiments of the invention involves sliding a credit card through a credit card reader and approving the charge to the credit card or putting cash in the cash acceptor in order to pay for the services and documents to be provided. As an additional security measure, the customer's credit card billing address may be compared against the customer's indicated home address, or a possible shipping address in certain embodiments, as a form of confirmation as to the identity of the customer.

The customer is then presented instructions on operating the medical instruments attached to the kiosk (Step 36). The customer may operate the medical instruments under the supervision of a medical professional through the interactive kiosk, or a medical professional, such as a nurse, may be present at the kiosk to assist or perform the examination for the doctor. The instrument readings are then sent to the medical professional terminal (Step 38). The customer is presented with a questionnaire as part of the requesting process during which the customer is asked a series of questions necessary for the particular medical document requested (Step 40). There are typically a set of questions general to most document requests, i.e. customer's date of birth, height, weight, known allergies, current medications, known medical problems, alcohol and cigarette intake, past surgeries, and the like. Additionally, there may be a set of specific screening questions specifically directed to the specific medical document being requested. For example, if a prescription is requested or needed, specific questions may be directed to confirming that a particular medication is right for the customer. For example, and without limitation, with the genital warts drug Aldara®, the questions may include:
1) Do you have lesions that appear to be warts on or near your genital area?
2) Does your rash look more like that shown in Picture 1,2 or 3? (Three pictures are shown)
3) Have you ever been diagnosed with Genital Warts, Human Papilloma Virus (HPV) or Venereal Warts?
   A) If so, did you ever receive treatment for these warts?
   B) If so, which of the following methods were used when you received treatment? (A list of possible treatments are shown)
   C) Did you have success with any of those treatments?
   D) Did you have any adverse reaction or reaction that prompted your doctor to discontinue treatment or advise you to not use that treatment in the future?
4) Have you had an HIV test?
5) Which of the following have you been tested for? (A list of other sexually transmitted diseases is shown)
6) Do you use any steroids?
7) Have you had an organ transplant?

Additional validation information may be requested to ensure that the customer is legally eligible to receive the requested medication. For example, and without limitation, the validations may include, with a Yes or No response required for each one:
1) If you receive a prescription for medication from this medical examination, you will use the medication solely for your own personal therapeutic and medical needs, and not to distribute any of the medication to others.
2) You will promptly contact a physician for any necessary medical intervention should a complication or concern result related to the medical services and documents requested.
3) Should you be issued a prescription pursuant to the medical examination, you realize that there are risks as well as benefits to any medication, even over-the-counter drugs. You have been informed of the possible effects, risks and benefits of this medication.
4) You certify that you are 21 years of age or older.
5) You are permitted by law to receive these products or services in this region/country/locale.
6) You understand the side-effect of any medications prescribed or distributed at the examination.
7) You understand that you cannot have a prescription for a medication from more than one physician.
8) You certify that you are allowed by law to use the credit card you have selected below.
9) You understand that your credit card will be billed for this consultation and that if you choose to have medication dispensed from a licensed pharmacist, this too will be billed to your account if your request is approved.
10) You certify that you have, and will, answer all questions truthfully.
11) You understand that in accordance with federal laws and rules, your personal medical and other information will be kept in confidence and will not be used for any commercial uses.

Additional information questions regarding the identity of the customer may also be asked such as billing information, address, gender, etc., or for previous users of the system this information may be loaded from an associated database. The computerized medical questionnaire may be interactive, in that some answers from the consumer may determine which question will be asked next. The questions may also be formulated by a medical professional conducting the medical examination.

The responses to the questions are analyzed (Step 42) as the questions are answered or when the answers are submitted. This is particularly the case when a medical professional is conducting the medical examination. The questions may also be analyzed by a medical professional at some later time. The medical professional determines whether or not the medical document should be issued (Step 44). The customer should be informed if the medical document will not issue (Step 46). Otherwise, if it is determined that the medical document should be issued, the type of medical document that was requested comes into play. It is also possible that more information may be needed by the medical professional to issue the medical document (Step 48). If this is the case, more questions should be asked to clarify any concerns the medical professional may have.

If the medical professional approves the issuance of the medical document, the customer may be given the option to have the document printed from the kiosk and/or forwarded directly to some other entity (Step 52 and 54). If the customer wants the document printed from the kiosk, it can be printed immediately (Step 60). Though, if a medical professional is not present during the examination, the customer may need to return for the document or for a follow up. The medical document is printed with the customer's image attached in order to allow verification of the identity of the person to whom the medical document relates. When someone is presented with the medical document, that person may verify that the person presenting the document is the person to whom the document was issued (Step 64 and 68). Once the identity of the customer is verified, the document can be accepted (Step 70). Otherwise the document is not accepted (Step 72). Instead of, or in addition to a photograph of a customer's facial image, it is possible that other biometric comparisons may be made to verify the identity of the customer. Other biometric comparisons may include comparing fingerprints, DNA, retinal scans, or any other unique identifier.

If the customer prefers to have the medical document forwarded to another entity, information is gathered about that entity (Step 56), such as where the entity is located, an email address or fax number, and the like. The document is then forwarded with the customer's image attached(Step 58). This allows the entity to which the document is presented, to verify that the customer is the person to whom the document was issued (Steps 62 and 66). If the identity of the customer is verified, the entity may accept the document otherwise, the entity can reject it (Steps 74 and 76).

Information gathered by the kiosk is stored in a medical database for further reference. The customer's request establishes a specific record of who requested the medical document and who was examined. It provides not only a confirmation that the customer was asked all of the appropriate questions and answered them appropriately, but also that a specific photo record was made of who requested the document, answered the questions and participated in the examination. This record is one that is generally not created in a conventional doctor's office when a medical document is requested.

An initial determination may be made from the response received from the medical database as to whether the customer should receive the medical document and pass that along with the customer's responses. For example, and without limitation, if the customer has frequently requested the same prescription medication without just cause, the same facial image is associated with more than one name, or more than one facial image is associated with the same name, software associated with the system may identify the inconsistency. This may be indicated to the doctor along with the medical document request. Also, if the database is aware of a conflicting prescription previously received by the customer that is not identified in the customer's responses, if previous responses are inconsistent with current responses, or if the indications otherwise indicate that the customer should not be using the requested medication, this too may be identified and indicated to the doctor along with the medical document request.

As will be clear to those of ordinary skill in the art, the medical information database used in embodiments of the present invention may be configured in many different ways and may include any number of different types of information. Those of ordinary skill in the art will be readily able to design and build an appropriate database depending upon the needs of a particular system and the information desired to be stored and retrieved by system administrators. In particular embodiments of the present invention, each request for a medical document along with all responses and all relationships between requests may be tracked, queried and searched. Such a system would increase the usefulness of the database in providing security against fraudulent prescription requests is dependent, in part, upon the ability to search and compare existing records.

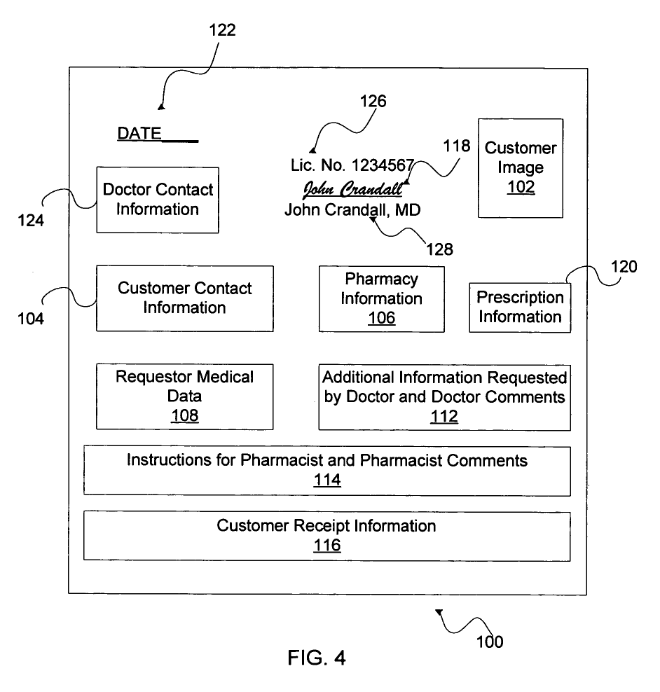

FIG. 4 illustrates an example of a prescription 100 generated according to a particular embodiment of the present invention. A prescription 100 generated according to specific embodiments of the present invention may include any or all of the elements described with reference to FIG. 4, in whatever combination is necessary or desired for a particular system. The prescription 100 shown and described with regard to this particular embodiment is intended as a non-limiting example. A prescription 100, or conditional prescription, configured according to the present embodiment, includes an image of the customer 102, the customer's contact information 104, information regarding the pharmacy 106 to which the customer indicated the prescription should be sent, and pertinent medical data 108 relating to the customer. The prescription 100 also includes a section for comments from the doctor 112, a section for specific instructions to the pharmacist and comments by the pharmacist 114, and a section for payment and perhaps delivery receipt information for the customer 116. Like a conventional prescription, a prescription 100 configured according to the embodiment of FIG. 4 also includes a doctor's signature 118, prescription information 120 regarding the medication, dosage and perhaps refills prescribed, and a date 122 for the prescription. Embodiments of the prescription may also include the doctor's full contact information 124, license number 126, and title below the signature 128 for clarity. Other medical documents may have similar fields for follow-up questions and other information.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims. For example, it should be clear to those of ordinary skill in the art from the present disclosure that many aspects of the present system and medical documents may be used independently to increase security and prevent fraud.

1. A medical service distribution system comprising:
a customer interface with a computer system; and
a camera associated with the customer interface and configured to capture an image of a customer at the customer interface;
wherein the customer interface is configured to receive a request for a medical document from the customer through an interface input, capture a facial image of the customer requesting the medical document proximate a time of the request through the camera, and generate, in response to the request, the requested medical document including the facial image of the customer requesting the medical document.

2. The medical service distribution system of claim 1, wherein the medical document is a prescription for a prescription drug or a letter concerning the customer's health.

3. The medical service distribution system of claim 1, wherein the customer interface allows the customer to see and speak to a medical professional.

4. The medical service distribution system of claim 1, further comprising medical instruments attached to the system in order to take medical readings from the customer.

5. The medical service distribution system of claim 1, wherein the customer interface displays instructions on how to perform a medical self examination.

6. The medical service distribution system of claim 1, further comprising a medical kit for emergency treatment.

7. The medical service distribution system of claim 1, further comprising a credit card or currency acceptor.

8. The medical service distribution system of claim 1, wherein the medical document is printed directly from the system.

9. The medical service distribution system of claim 1, further comprising an emergency button which summons professional medical help.

10. The medical service distribution system of claim 1, further comprising at least one video camera, wherein the at least one video camera allows the customer to show a medical professional any physical symptoms that the customer may have.

11. The medical service distribution system of claim 10, wherein the at least one video camera allows the medical professional to monitor the customer's use of the customer interface.

12. A method of providing medical documents, the method comprising:
receiving a request for a medical examination from a customer through a customer interface with a computer;
receiving information concerning the customer through the customer interface with a computer;
receiving a request from the customer for a medical document through the customer interface with a computer;
capturing a facial image of the customer requesting the medical document proximate a time of the request through the customer interface with a computer; and
generating a medical document with the customer's image in response to the request through the customer interface with a computer.

13. The method of claim 12, further comprising receiving responses from the customer to a plurality of medical questions related to the medical examination proximate the time of the request through the customer interface with a computer.

14. The method of claim 12, further comprising confirming an identity of the customer having the medical document by comparing the image on the medical document to the customer.

15. The method of claim 12, wherein the information received through the customer interface with a computer concerning the customer consists partially of instrument readings such as blood pressure, pulse rate and the like.

16. The method of claim 15, wherein a medical professional directs the customer in the use of medical instruments through the customer interface with a computer, wherein the medical instruments are part of the customer interface.

17. The method of claim 15, wherein a medical professional directs the customer on medical procedures in cases of emergency through the customer interface with a computer.

18. The method of claim 12, wherein the medical document is a prescription for prescription drugs or a letter stating the customer's health.

19. A method of issuing medical documents, the method comprising:
a medical professional communicating with a customer through a customer interface with a computer;
the medical professional directing the customer in taking readings using medical instruments, wherein the medical instruments are part of the customer interface with a computer;
the medical professional asking the customer medical questions through the customer interface with a computer;
the medical professional receiving a request for a medical document through the customer interface with a computer which captures a facial image of the customer requesting the medical document proximate a time of the request; and
the medical professional issuing, through the customer interface with a computer, the medical document attached to the facial image of the customer in order to allow verification of the identity of the customer as the owner of the medical document.

20. The method of claim 19, wherein the customer interface with a computer further comprises at least one video camera which allows a medical professional and the customer to view each other.
